(19) United States
(12) Patent Application Publication
(10) Pub. No.: US 2018/0051042 A1
(43) Pub. Date: Feb. 22, 2018

(54) METHODS FOR FORMING SATURATED (HETERO)CYCLIC BORYLATED HYDROCARBONS AND RELATED COMPOUNDS

(71) Applicant: BOARD OF TRUSTEES OF MICHIGAN STATE UNIVERSITY, East Lansing, MI (US)

(72) Inventors: Milton R. Smith, III, East Lansing, MI (US); Timothy M. Shannon, Lansing, MI (US); Robert E. Maleczka, JR., Dewitt, MI (US); Ryan M. Fornwald, East Lansing, MI (US)

(21) Appl. No.: 15/682,636

(22) Filed: Aug. 22, 2017

Related U.S. Application Data
(60) Provisional application No. 62/377,807, filed on Aug. 22, 2016.

(51) Int. Cl. C07F 5/02; C07F 7/08; C07F 5/04

(52) U.S. Cl. CPC C07F 5/025; C07F 7/0827; C07F 5/04; C07F 7/082

(57) ABSTRACT

The disclosure relates to methods for forming at least partially saturated cyclic and heterocyclic borylated hydrocarbons, as well as related compounds, which can be precursor compounds in the synthesis of any of a variety of pharmaceutical or medicinal compounds with a desired structure and/or stereochemistry for drug synthesis or drug candidate evaluation. The methods generally include reduction of an unsaturated cyclic or heterocyclic borylated hydrocarbon having a boron-containing substituent at an sp²-carbon, where such reduction converts the sp²-carbon to an sp³-carbon at the point of attachment of the boron-containing substituent. The methods can exhibit a selectivity for syn-addition during reduction, which can provide stereospecific products, such as when the unsaturated cyclic or heterocyclic reactant is multiply substituted with boron groups and/or other functional groups.

### CROSS REFERENCE TO RELATED APPLICATION

Priority is claimed to U.S. Provisional Application No. 62/377,807 filed Aug. 22, 2016, which is incorporated herein by reference in its entirety.

### STATEMENT OF GOVERNMENT INTEREST

This invention was made with government support under GM063188 awarded by the National Institutes of Health. The government has certain rights in the invention.

### BACKGROUND OF THE DISCLOSURE

### Field of the Disclosure

The disclosure relates to methods for forming at least partially saturated cyclic and heterocyclic borylated hydrocarbons, as well as related compounds, which can be precursor compounds in the synthesis of any of a variety of pharmaceutical or medicinal compounds with a desired structure and/or stereochemistry for drug synthesis or drug candidate evaluation. The methods generally include reduction of an unsaturated cyclic or heterocyclic borylated hydrocarbon having a boron-containing substituent at an sp²-carbon, where such reduction converts the sp²-carbon to an sp³-carbon at the point of attachment of the boron-containing substituent. The methods can exhibit a selectivity for syn-addition during reduction, which can provide stereospecific products, such as when the unsaturated cyclic or heterocyclic reactant is multiply substituted with boron groups and/or other functional groups.

### BACKGROUND

Borylated cyclic or heterocyclic compounds can be useful as precursor compounds for drug synthesis or drug candidate evaluation. Current methods of borylating a cyclic or heterocyclic substrate are often limited to attachment of a boron-containing substituent or group to an sp²-carbon of an unsaturated cyclic or heterocyclic substrate. Conversely, methods for attaching a boron-containing substituent or group to an sp³-carbon of an at least partially saturated cyclic or heterocyclic substrate are unknown for some substrates or difficult/inefficient for other substrates. Difficulty in forming sp³-carbon-substituted boron groups can limit the scope of a corresponding method for drug synthesis or drug candidate evaluation.

### SUM MARY

In an aspect, the disclosure relates to a method for forming an at least partially saturated cyclic or heterocyclic borylated hydrocarbon, the method comprising: (a) providing a cyclic or heterocyclic unsaturated (e.g., aromatic) hydrocarbon comprising (i) at least one boron group at an sp²-carbon of the unsaturated hydrocarbon (e.g., 1, 2, 3, 4, 5, 6, or more boron (or boron-containing) groups where the boron atom of the group is bonded to the sp²-carbon (i.e., at different carbons when more than 1 boron group is present), which boron groups can be in the same or different), and (ii) optionally at least one other functional group (e.g., R, R1, R2, A, etc. as described below and illustrated in the various reaction schemes) at an sp²-carbon of the unsaturated hydrocarbon (e.g., 1, 2, 3, 4, 5, 6, or more other functional groups which are other than a hydrogen atom and either do not contain boron at all, or do not contain a boron atom bonded to an sp²-carbon atom of the (hetero)cyclic unsaturated hydrocarbon); and (b) reducing the cyclic or heterocyclic unsaturated hydrocarbon, thereby forming an at least partially saturated corresponding cyclic or heterocyclic hydrocarbon product comprising the at least one boron group at an sp³-carbon of the at least partially saturated hydrocarbon product. The sp³-carbon is the original sp²-carbon for boron group attachment prior to reduction. In various refinements of the method and/or resulting hydrocarbon product, the cyclic or heterocyclic unsaturated hydrocarbon has at least one of the following characteristics: (i) the cyclic or heterocyclic unsaturated hydrocarbon comprises the at least one other functional group (e.g., as a cyclic or heterocyclic ring substituent at an sp²- or sp³-carbon); (ii) the cyclic or heterocyclic unsaturated hydrocarbon is other than a substituted pyrrole; (iii) the cyclic or heterocyclic unsaturated hydrocarbon is a heterocyclic unsaturated hydrocarbon comprising a heteroatom selected from the group consisting of nitrogen, oxygen, sulfur, and combinations thereof, wherein the heteroatom is in the form of —NH—, —NR—, —N═, —O—, —S—, —PH—, —PR—, and —P═, where R, when present, is selected from the group consisting of alkyl groups, fused cycloalkyl derivatives thereof, aryl groups, halogens, amide groups, silyl groups, and heteroatom-containing derivatives thereof; and/or (iv) the cyclic or heterocyclic unsaturated hydrocarbon is a cyclic unsaturated hydrocarbon (e.g., the unsaturated hydrocarbon reactant can have any combination of the foregoing characteristics, as long as they are not mutually exclusive).

In another aspect, the disclosure relates to a cyclic or heterocyclic hydrocarbon product comprising: an at least partially saturated cyclic or heterocyclic hydrocarbon product comprising: (i) at least one boron group at an sp³-carbon of the hydrocarbon product, and (ii) optionally at least one other functional group at an sp³-carbon of the hydrocarbon product. The hydrocarbon product generally can correspond to the reaction product as formed by the disclosed methods in any of their various embodiments and refinements. In a refinement, the at least partially saturated cyclic or heterocyclic hydrocarbon product has at least one of the following characteristics: (A) the at least partially saturated cyclic or heterocyclic hydrocarbon product comprises the at least one other functional group; (B) the at least partially saturated cyclic or heterocyclic hydrocarbon product is other than a partially or fully saturated substituted pyrrole analog (e.g., a substituted pyrrolidine); (C) the at least partially saturated cyclic or heterocyclic hydrocarbon product is an at least partially saturated heterocyclic hydrocarbon product comprising a heteroatom selected from the group consisting of nitrogen, oxygen, sulfur, and combinations thereof, wherein the heteroatom is in the form of NH—, —NR—, —N═, —O—, —S—, —PH—, —PR—, and —P═, where R, when present, is selected from the group consisting of alkyl groups, fused cycloalkyl derivatives thereof, aryl groups, halogens, amide groups, silyl groups, and heteroatom-containing derivatives thereof; and (D) the at least partially saturated cyclic or heterocyclic hydrocarbon product is an at least partially saturated cyclic hydrocarbon product. In a refinement, the hydrocarbon product is an at least partially saturated (e.g., completely saturated) cyclic or heterocyclic analog of a cyclic or heterocyclic unsaturated hydrocarbon selected from the group consisting of a substituted cyclopentadiene, a substituted benzene, a substituted naphthalene, a substituted anthracene, a substituted perylene, a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, and a substituted diazene. In another refinement, the hydrocarbon product is an at least partially saturated (e.g., completely saturated) heterocyclic analog of a substituted pyrrole, and the at least one other functional group is present as a silyl group. In another refinement, the hydrocarbon product is an at least partially saturated (e.g., completely saturated) heterocyclic analog of a substituted pyrrole, the boron group is at an sp³-carbon in a 3-position relative to the nitrogen heteroatom of the hydrocarbon product, and the at least one other functional group is present at an sp³-carbon in a 5-position relative to the nitrogen heteroatom of the hydrocarbon product. In another refinement, the hydrocarbon product is an at least partially saturated (e.g., completely saturated) heterocyclic analog of a substituted pyrrole, the boron group is at an sp³-carbon in a 2-position relative to the nitrogen heteroatom of the hydrocarbon product, and at least two other functional groups are present, including a first functional group at an sp³-carbon in a 4-position relative to the nitrogen heteroatom of the hydrocarbon product and a second functional group at an sp³-carbon in a 5-position relative to the nitrogen heteroatom of the hydrocarbon product. In another refinement, the at least partially saturated cyclic or heterocyclic hydrocarbon product is selected from compounds 5-7, 10, 12, 13, and 15 shown in FIG. 5 (e.g., where the boron group can be any boron group disclosed herein or the illustrated Bpin, BMIDA, or B(OH)₂ group). In another refinement, the at least partially saturated cyclic or heterocyclic hydrocarbon product is selected from compounds 17-21 shown in FIG. 6 (e.g., where the boron group can be any boron group disclosed herein or the illustrated Bpin, B(OR)₂, or B(OH)₂ group). In another refinement, the at least partially saturated cyclic or heterocyclic hydrocarbon product is selected from the 2-borylated at least partially saturated pyridine analogs shown in FIG. 7 (e.g., where the boron group can be any boron group disclosed herein).

In another aspect, the disclosure relates to a method for forming an at least partially saturated cyclic or heterocyclic silylated hydrocarbon, the method comprising: (a) providing a cyclic or heterocyclic unsaturated (e.g., aromatic) hydrocarbon comprising (i) optionally at least one boron group at an sp²-carbon of the unsaturated hydrocarbon, and (ii) at least one silyl functional group (e.g., —SiR₃, where R can be the same or different alkyl groups as disclosed herein) at an sp²-carbon or an sp³-carbon of the unsaturated hydrocarbon; and (b) reducing (e.g., hydrogenating as disclosed herein) the cyclic or heterocyclic unsaturated hydrocarbon, thereby forming an at least partially saturated corresponding cyclic or heterocyclic hydrocarbon product comprising the at least one silyl functional group at an sp³-carbon of the at least partially saturated hydrocarbon product (e.g., and further comprising the at least one boron group at an sp³-carbon of hydrocarbon product when present in the reactant unsaturated hydrocarbon). The silyl functional group(s) and the boron group(s) (when present) can be in preferred syn orientation.

Various refinements of the disclosed methods and resulting products are possible.

In a refinement, the cyclic or heterocyclic unsaturated hydrocarbon is a cyclic unsaturated hydrocarbon, for example where cyclic unsaturated hydrocarbon is selected from the group consisting of a substituted cyclopentadiene, a substituted benzene, a substituted naphthalene, a substituted anthracene, and a substituted perylene.

In another refinement, the cyclic or heterocyclic unsaturated hydrocarbon is a heterocyclic unsaturated hydrocarbon. For example, the heterocyclic unsaturated hydrocarbon can comprise a heteroatom selected from the group consisting of nitrogen, oxygen, sulfur, phosphorous, and combinations thereof. In various further refinements, the boron group is at an sp²-carbon in a 2-position relative to the heteroatom, the boron group is at an sp²-carbon in a 3-position relative to the heteroatom, and/or the boron group is at an sp²-carbon in a 4-position relative to the heteroatom (e.g., multiple location combinations are possible when more than one boron group is present in the unsaturated hydrocarbon reaction substrate). Alternatively or additionally, the heterocyclic unsaturated hydrocarbon can be selected from the group consisting of a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, and a substituted diazene.

In another refinement, the cyclic or heterocyclic unsaturated hydrocarbon is fully unsaturated. In an alternative refinement, the cyclic or heterocyclic unsaturated hydrocarbon is partially unsaturated.

In another refinement, the boron group is selected from the group consisting of boronic acids (e.g., —B(OH)₂), boronic esters (e.g., —B(OR)₂), alkyl boranes (e.g., —BR₂), boryl halides (e.g., —BF₂ or with other halogens) and haloborate salts thereof (e.g., —BF₃K or with other halogens/alkali metals), cyclic derivatives thereof (e.g., Bpin (pinacolato boronate) as a cyclic ester), fused cyclic derivatives thereof (e.g., —B(OR¹)R², where R² is an carbon and/or nitrogen containing group where carbon or nitrogen is bonded to boron, forming a fused cyclic structure and bonded to a different carbon in the unsaturated hydrocarbon than that of the boron), heteroatom-substituted derivatives thereof (e.g., BMIDA (N-methyliminodiacetic acid) as a cyclic boronic ester with a nitrogen group; boron substituted with 1,8-diaminonapthalene (Bdan), 1,2-ethylene diamine (Ben), 1,2-N,N′-dimethylethylenediamine (Bdmen), and combinations thereof (e.g., as separate boron groups in an unsaturated hydrocarbon with multiple boron groups and/or a single boron group with multiple functionalities). For example, the boron group can be Bpin, B(OH)₂, BMIDA, Bdan, Ben, or Bdmen (or combinations thereof).

In another refinement, the cyclic or heterocyclic unsaturated hydrocarbon comprises at least two boron groups. For example, the cyclic or heterocyclic unsaturated hydrocarbon can comprise at least two different boron groups. Yet further, the at least two boron groups can be positioned at corresponding sp³-carbons of the hydrocarbon product in a syn orientation, for example where at least 60% of the at least two boron groups are positioned in the hydrocarbon product in a syn orientation.

In another refinement, the cyclic or heterocyclic unsaturated hydrocarbon comprises the at least one other functional group (R). For example, the other functional group can be selected from the group consisting of alkyl groups (e.g., C1-C20 linear or branched alkyl), fused cycloalkyl derivatives thereof, alkenyl groups (e.g., C1-C20 linear or branched alkenyl; which can be partially or completely saturated during reduction), aryl groups (e.g., phenyl, naphthyl; which can be partially or completely saturated during reduction or left intact), halogens (e.g., Cl, F, Br, I), ester groups (e.g., with either the carbonyl group or oxygen atom bound to the unsaturated hydrocarbon; —C(═O)OR or —OC(═O)R such as where R is alkyl), amide groups (e.g., with either the carbonyl group or nitrogen atom bound to the unsaturated hydrocarbon; —C(═O)NR¹R² or —NR¹C(═O)R² such as where R¹ is hydrogen or alkyl and R² is the same or different alkyl), silyl groups (e.g., —SiR₃, where R can be the same or different alkyl groups), and heteroatom-containing derivatives thereof.

In another refinement, the other functional group is positioned at an sp²-carbon of the unsaturated hydrocarbon. For example, the boron group and the other functional group can be positioned at adjacent sp²-carbons of the unsaturated hydrocarbon, and the boron group and the other functional group can be positioned at corresponding adjacent sp³-carbons of the hydrocarbon product in a syn orientation, for example where at least 60% of the boron groups and the other functional groups are positioned in the hydrocarbon product in a syn orientation. Alternatively, the boron group and the other functional group can be positioned at non-adjacent sp²-carbons of the unsaturated hydrocarbon, and the boron group and the other functional group can be positioned at corresponding adjacent sp³-carbons of the hydrocarbon product in a syn orientation, for example where at least 60% of the boron groups and the other functional groups are positioned in the hydrocarbon product in a syn orientation.

In another refinement, reducing the cyclic or heterocyclic unsaturated hydrocarbon in part (b) comprises hydrogenating the cyclic or heterocyclic unsaturated hydrocarbon to form the corresponding hydrocarbon product. Hydrogenating the cyclic or heterocyclic unsaturated hydrocarbon can be performed in the presence of a heterogeneous hydrogenation catalyst, which can comprise a metal selected from the group consisting of rhodium, palladium, platinum, iridium, ruthenium, nickel, osmium, and combinations thereof (e.g., where the metal can be supported on a suitable substrate such as carbon, alumina, etc.). Alternatively, hydrogenating the cyclic or heterocyclic unsaturated hydrocarbon can be performed in the presence of a chiral hydrogenation catalyst.

In another refinement, reducing the cyclic or heterocyclic unsaturated hydrocarbon is performed in the presence of a homogeneous reduction catalyst (e.g., where the homogeneous reduction catalyst comprises sodium borohydride).

In another refinement, providing the cyclic or heterocyclic unsaturated hydrocarbon in part (a) comprises: borylating a corresponding cyclic or heterocyclic unsaturated hydrocarbon precursor comprising the at least one other functional group (when present), but without the at least one boron group, thereby forming the cyclic or heterocyclic unsaturated hydrocarbon comprising the at least one boron group added to an sp²-carbon of the unsaturated hydrocarbon and the at least one other functional group (when present). In a further refinement, borylation of the unsaturated hydrocarbon precursor and the reduction of the unsaturated hydrocarbon can be performed in the same reaction vessel.

While the disclosed compounds, methods and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates reaction schemes according to the disclosure for borylation of an unsaturated cyclic or heterocyclic hydrocarbon substrate, followed by reduction of the same to provide an at least partially saturated product (Scheme 1).

FIG. 2 illustrates reaction schemes for forming at least partially saturated cyclic or heterocyclic hydrocarbons with both syn- and anti-configurations for ring substituents (Scheme 2).

FIG. 3 illustrates classes of variously known, commercially available, or unknown piperidines (top row) and pyrrolidines (bottom row).

FIG. 4 illustrates a known method for hydrogenation of a 2-borylated N-Boc (tert-butoxy carbonyl)-pyrrole according to Kelly et al. (1993) (Scheme 3).

FIG. 5 illustrates a reaction scheme according to the disclosure for hydrogenation of an unsaturated heterocyclic borylated hydrocarbon substrate to form an at least partially saturated product (Scheme 4).

FIG. 6 illustrates a reaction scheme according to the disclosure for hydrogenation of an unsaturated cyclic borylated hydrocarbon substrate to form an at least partially saturated product (Scheme 5).

FIG. 7 illustrates representative saturated cyclic and heterocyclic reaction substrates and at least partially saturated cyclic and heterocyclic reaction products according to the disclosure.

FIG. 8 illustrates a reaction scheme according to the disclosure for asymmetric transformation/reduction of an unsaturated cyclic borylated hydrocarbon to selectively yield specific stereoisomer products (Scheme 6).

### DETAILED DESCRIPTION

The disclosure relates to methods for forming at least partially saturated cyclic and heterocyclic borylated hydrocarbons, as well as related compounds, which can be precursor compounds in the synthesis of any of a variety of pharmaceutical or medicinal compounds with a desired structure and/or stereochemistry for drug synthesis or drug candidate evaluation. The methods generally include reduction of an unsaturated cyclic or heterocyclic borylated hydrocarbon having a boron-containing substituent at an sp²-carbon, where such reduction converts the sp²-carbon to an sp³-carbon at the point of attachment of the boron-containing substituent. The methods can exhibit a selectivity for syn-addition during reduction, which can provide stereospecific products, such as when the unsaturated cyclic or heterocyclic reactant is multiply substituted with boron groups and/or other functional groups.

As disclosed herein, hydrogenation and other reductions of unsaturated, aromatic and heteroaromatic cyclic borylated compounds using metal or other catalysts can be used to generate corresponding borylated fully or partially saturated cyclic compounds. The aromatic and heteroaromatic borylated compounds with groups at sp²-carbons can be made, for example, through a variety of conventional techniques such as iridium-catalyzed borylation, palladium couplings of diboron reagents, metalation/borylation reactions, and other processes. Hydrogenation of the unsaturated compound can be performed, for example, using catalysts on heterogeneous supports or homogeneous catalysts. Related reductions with sodium, or other alkali metals, are also possible. Likewise, partial reductions can be carried out. These approaches provide selective routes to the formation of saturated (or partially saturated) substituted cyclic and heterocyclic compounds with a boron group (e.g., in the form of a boronic acid or ester substituent) at an sp³-carbon (i.e., including a B-C bond at an sp³-carbon of the reduced cyclic compound). In some cases, ring-opening of the heterocyclic products could be observed (e.g., forming a ring-opened analog of the at least partially saturated cyclic or heterocyclic hydrocarbon product typically formed). Such compounds with a boron group at an sp³-carbon can be extremely difficult to make from saturated carbocycles and heterocycles. In certain cases, there is no known method to make specific compounds of interest.

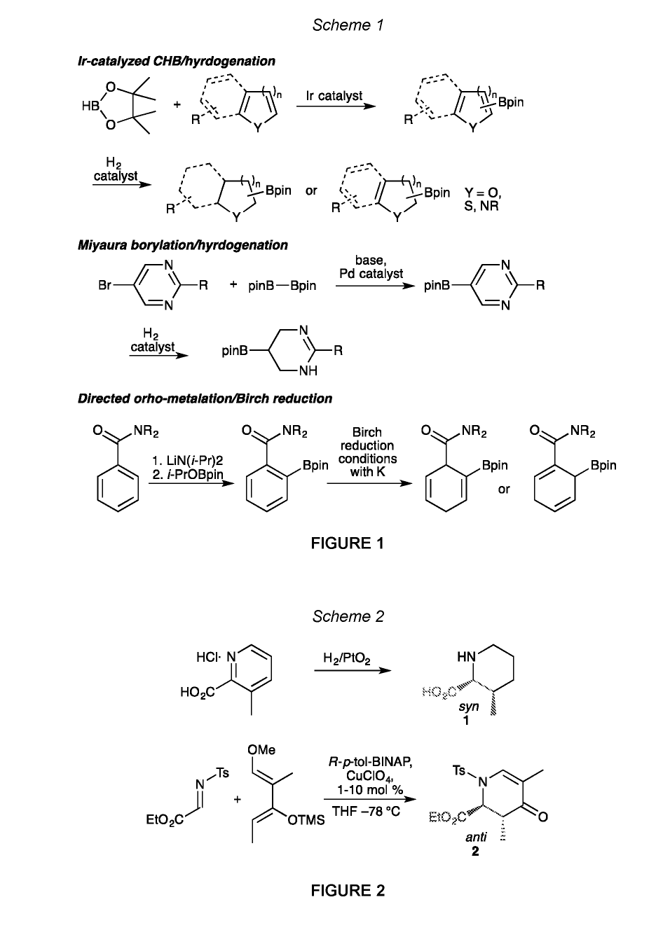

It would be desirable to have efficient and selective methods of forming sp³-carbon borylated cyclic or heterocyclic compounds (i.e., including C—H borylations or “CHBs”), in which case borylated cyclic or heterocyclic compounds can be used as chemical synthetic precursors (e.g., for drug synthesis or otherwise). The disclosed method utilizes a wide range of conventional techniques available to form unsaturated cyclic or heterocyclic compounds which include borylated sp²-carbons. FIG. 1 (Scheme 1) illustrates representative techniques such as sp² heteroarene C—H borylations (CHBs), Miyaura borylations, and other B—C bond-forming reactions to precursors to sp³-borylated heterocycles that involve modification of borylated aromatic core templates to saturated or partially saturated systems via reductions and/or other elaborations. FIG. 2 (Scheme 2) illustrates reaction schemes for forming at least partially saturated cyclic or heterocyclic hydrocarbons with both syn- and anti-configurations for ring substituents. Given that hydrogenations in most cases proceed with a syn addition of hydrogen (H₂; for example as illustrated by hydrogenation of the unsaturated heterocycle in FIG. 2 to form compound 1), synthesis of functionalized sp³ frameworks via this approach complements construction of sp³ structures from unsaturated components, where steric effects typically favor favor anti conformations (e.g., as illustrated by reaction of two unsaturated reactants in FIG. 2 to form compound 2).

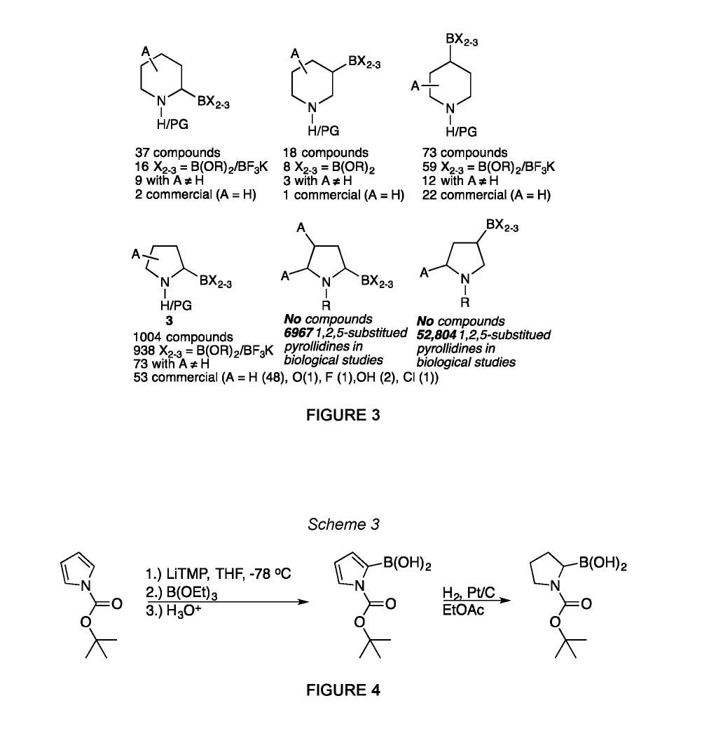

Despite the vast array of substituted piperdines, azepanes, and pyrrolidines present in new drug candidates, methods for preparing borylated analogs are limited and commercial availability for many structures is limited to the otherwise unsubstituted parent heterocycles. FIG. 3 illustrates classes of variously known, commercially available, or unknown borylated piperidines (top row) and borylated pyrrolidines (bottom row), where BX₂₋₃ generically represents a boron group according to the disclosure (e.g., boronic acid, boronic ester, haloborate salts, or otherwise). The borylated pyrrolidines illustrated as compound 3 have the largest number of examples identified from a search. Of 938 structures, only 73 have a non-hydrogen substituent on the ring carbons, and only 5 of the 53 commercially available compounds have non-hydrogen carbon substituents. Only 4 commercially available borylated azepanes are known. Moreover, of the 54 2-borylated pyrrolidines, only 3 carry additional other substituents (Me, Cl, and F) are reported to be commercial, with all three said to be provided by a single vendor who lists them as being “intermittently available.” As shown in FIG. 3, 2-borylated-4,5-disubstituted pyrrolidines and 3-borylated-4-substituted pyrrolidines are not known. FIG. 4 (Scheme 3) illustrates a known method for hydrogenation of a 2-borylated N-Boc (tert-butoxy carbonyl)-pyrrole.

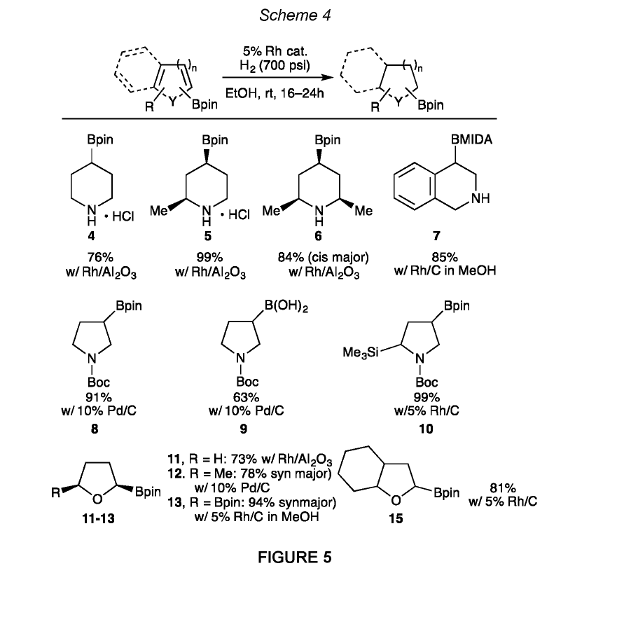

FIG. 5 (Scheme 4) illustrates a reaction scheme according to the disclosure for hydrogenation of an unsaturated heterocyclic borylated hydrocarbon substrate to form an at least partially saturated product (e.g., where Bpin can represent any desired boron group and R can represent any other functional group as generally described herein). Compounds 4-13 and 15 were formed according to the disclosure with a variety of alumina- or carbon-supported catalysts as indicated in FIG. 5. Hydrogenation under rhodium (Rh) or palladium (Pd) catalysis proved effective for the saturation of several pyridines and isoquinolines (compounds 4-7), pyrroles (compounds 8-10), and furans (compounds 11-12). It is worth noting that for the heteroarenes with additional substituents the hydrogenations tend to favor the syn isomers. Thus this method can be viewed as a complement to hydroboration of olefin-containing analogs. Installation of MIDA in place of pin in the starting isoquinoline was used to obtain product compound 7 (i.e., having a BMIDA boron group instead of Bpin as illustrated for some other products). This, as well as compound 9 with a boronic acid (B(OH)₂) boron group in both the reactant and corresponding product, show that the disclosed method is not limited to Bpin boron groups. This further indicates that polyborylated compounds (e.g., including Bpin and BMIDA or other boron groups) could be used as reaction substrates. Given that Bpin groups can be selectively transformed in the presence of BMIDA groups, the B-bonds in the saturated products can be manipulated with precision. In this regard, compound 10 demonstrates that both silicon-containing groups and boron groups are retained in the pyrrolidine product. There are no pyrrolidines in the literature that contain both boron and silicon-containing groups. Since there are numerous examples of B—C and Si—C transformations in the literature, and it is possible to transform one of these bonds selectively in the presence of the other, access to structures like 10 should have far-reaching synthetic applications. Compounds 5-7, 10, 12, 13, and 15 were previously unknown.

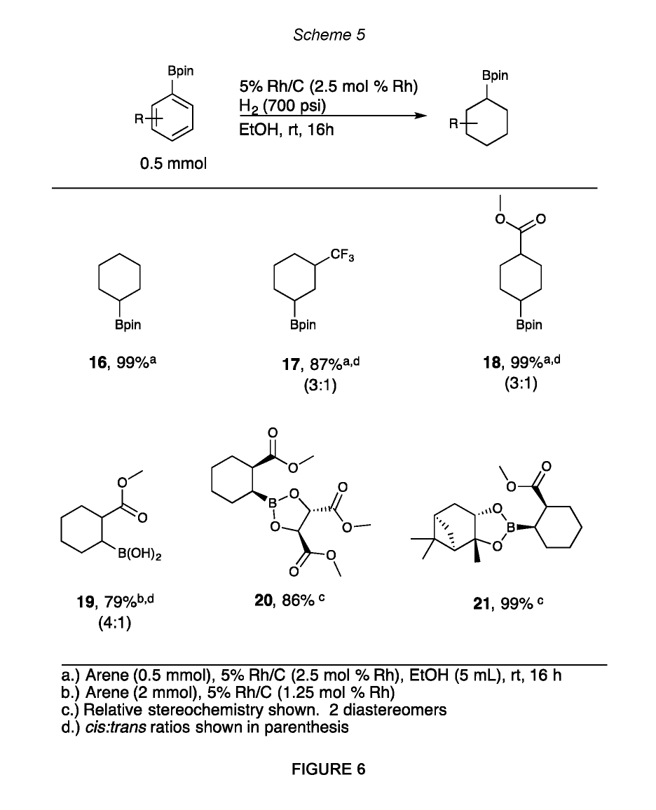

FIG. 6 (Scheme 5) illustrates a reaction scheme according to the disclosure for hydrogenation of an unsaturated cyclic borylated hydrocarbon substrate to form an at least partially saturated product (e.g., where Bpin can represent any desired boron group and R can represent any other functional group as generally described herein). Compounds 16-21 were formed from a corresponding fully unsaturated arene substrate. Compound 16 can be alternatively prepared by hydroboration of cyclohexene as known in the art, but compounds 17-21 were unknown, including more generally 3-borylated trifluoromethyl cyclohexanes (e.g., as an extension of compound 17 with possible further substituents).

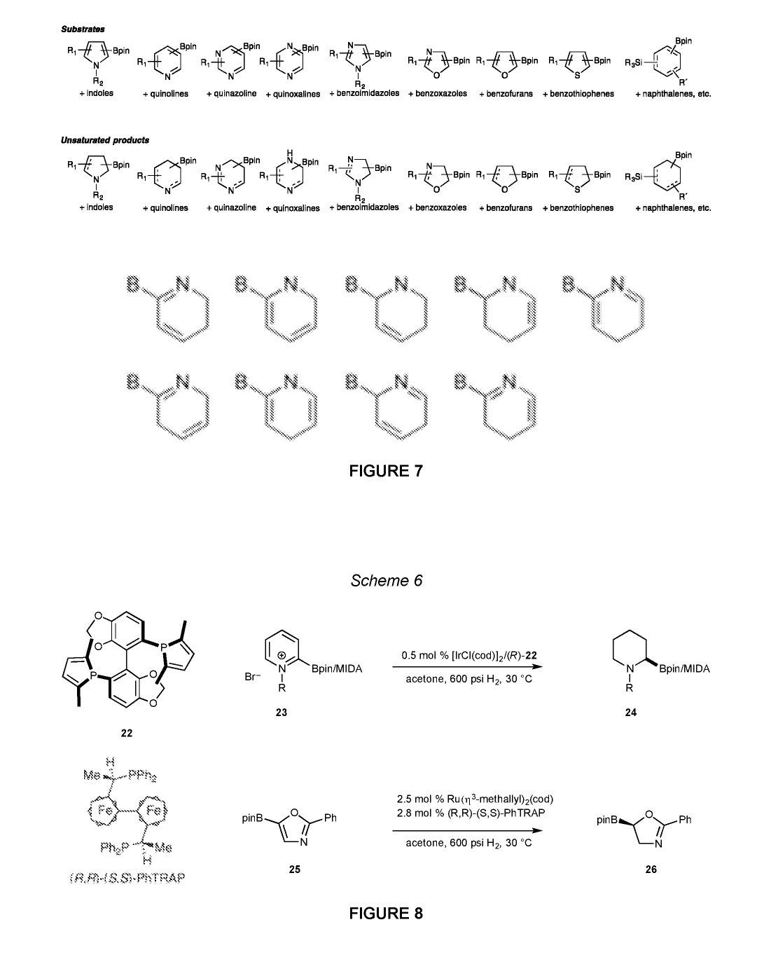

FIG. 7 illustrates representative saturated cyclic and heterocyclic reaction substrates and at least partially saturated cyclic and heterocyclic reaction products according to the disclosure (e.g., where Bpin or B can represent any desired boron group and R, R′, R₁, R₂, etc. can represent any other functional group as generally described herein). The disclosed reduction methods (e.g., heterogeneous catalytic hydrogenation as illustrated above or other reduction such as by sodium, sodium borohydride, etc.) can be applied to the various borylated heteroarene and arene substrates shown in the top portion of the figure. The top portion of the figure further illustrates corresponding at least partially saturated (or completely saturated) reaction products that could be obtained with the disclosed methods. The bottom portion of the figure illustrates a series of 2-borylated partially saturated reaction products (e.g., resulting from partial reduction of a 2-borylated pyridine substrate) that are unknown.

The disclosed methods could be applied to asymmetric transformations with chiral catalysts, which could be extremely useful since many transformations of boron atoms bound to sp³-carbon atoms are stereospecific. Transformations that yield single stereoisomers are very important since biological activities of enantiomers are rarely the same. FIG. 8 (Scheme 6) illustrates examples of these reactions, for example including asymmetric hydrogenation of borylated pyridiniums (compound 23) to afford chiral piperidines (compound 24), and partial hydrogenation of oxazole (compound 25) to oxazoline (compound 26), and are based on reactions of corresponding non-borylated pyridinium and oxazole compounds.

Reduction (e.g., hydrogenation or otherwise) of the cyclic or heterocyclic unsaturated borylated hydrocarbon substrate can be performed by any suitable method known in the art (e.g., a reduction method known for corresponding hydrocarbon substrates, whether or not borylated), including selection of suitable reaction conditions (temperature, pressure), solvent medium, heterogeneous or homogeneous catalyst, etc. The following illustrative hydrogenation reduction was used to form many of the reaction products shown in the figures and examples, and it is more generally applicable to the various cyclic or heterocyclic unsaturated borylated hydrocarbon substrates disclosed herein. In a 300 mL Parr pressure reactor, the glass liner was loaded with a solid-supported heterogeneous catalyst (2.5 mol. %), a cyclic or heterocyclic unsaturated borylated hydrocarbon reaction substrate (0.5 mmol), and ethanol as a solvent/reaction medium (5 mL). A stir bar was added and the reactor was closed. The reactor was pressurized to about 300 psi, and then the gas was released. This purging process was performed three times to ensure a purely hydrogen atmosphere. Following the purging of the reactor, the hydrogen gas was pressurized to about 700 psi and allowed to react at approximately room temperature (e.g., about 20° C. to about 30° C.) for about 16-24 hours. Upon completion, the pressure was released slowly and the reactor was opened. The resulting product suspension was filtered through diatomaceous earth (e.g., CELITE) and washed with methanol. The filtrate was concentrated under vacuum to yield the hydrogenated product.

### Methods of Forming Saturated (Hetero)Cyclic Borylated Hydrocarbons

The disclosure relates to a method for forming an at least partially saturated cyclic or heterocyclic borylated hydrocarbon by reduction of a cyclic or heterocyclic unsaturated (e.g., aromatic) borylated hydrocarbon. The reaction generally converts at least one sp²-carbon via hydrogen atom addition to an sp³-carbon at the point of boron attachment in the substrate (e.g., some or all sp²-carbons including boron groups in the reaction substrate are converted to sp³-carbons when the substrate has multiple boron groups). The reactant substrate is a cyclic or heterocyclic unsaturated (e.g., aromatic) hydrocarbon which includes at least one boron group at an sp²-carbon of the unsaturated hydrocarbon (e.g., 1, 2, 3, 4, 5, 6, or more boron (or boron-containing) groups where the boron atom of the group is bonded to the sp²-carbon (i.e., at different carbons when more than 1 boron group is present), which boron groups can be the same or different as described below). The heterocyclic unsaturated hydrocarbon reactant optionally includes at least one other functional group (e.g., R, R′, R1, R2, A, etc. as illustrated in the various reaction schemes) at an sp²-carbon of the unsaturated hydrocarbon (e.g., 1, 2, 3, 4, 5, 6, or more other functional groups which are other than a hydrogen atom and either do not contain boron at all, or do not contain a boron atom bonded to an sp²-carbon atom of the (hetero)cyclic unsaturated hydrocarbon). The unsaturated hydrocarbon is chemically reduced (e.g., hydrogenated), which forms as a reaction product an at least partially saturated corresponding cyclic or heterocyclic hydrocarbon product. The reduction process results in addition of a hydrogen atom to the sp²-carbon at the point of attachment of the boron group, and hydrocarbon product accordingly includes the boron group at an sp³-carbon of the at least partially saturated hydrocarbon product (e.g., and further including the other functional group when present in the reactant unsaturated hydrocarbon). The characteristic that the hydrocarbon reaction product is “at least partially saturated” is a relative term indicating that at least some (or all) of the unsaturated bonds in the original unsaturated hydrocarbon reactant have been converted to single bonds. The location of the other functional (R) group at an sp²-carbon can result in a syn-addition product with the R group being at a (reduced) sp³-carbon in the product, along with the boron group oriented in the same direction/orientation in the reaction product. In some embodiments, the sp²-carbon containing the R group might not be reduced (e.g., such as in a partial reduction and no hydrogen is added to the sp²-carbon containing the R group), and the R group will be still at the sp²-carbon in the hydrocarbon product. In other embodiments, a functional group R can be initially at an sp³-carbon (e.g., such as in an only partially unsaturated hydrocarbon reaction substrate), which remains an sp³-carbon in the product.

Various embodiments of the cyclic or heterocyclic unsaturated hydrocarbon reaction substrate are possible. For example, the unsaturated hydrocarbon reactant can be fully unsaturated (e.g., contains the maximum possible number of sp²-carbons based on the number carbons and heteroatoms (when present) in the (hetero)cyclic structure). Alternatively, the unsaturated hydrocarbon reactant can be partially unsaturated (e.g., contains less than the maximum possible number of sp²-carbons based on the number carbons and heteroatoms (when present) in the (hetero)cyclic structure, such as where the unsaturated hydrocarbon reactant includes one or more sp³-carbons).

In some embodiments, the unsaturated hydrocarbon reaction substrate is a cyclic unsaturated hydrocarbon (e.g., the hydrocarbon ring forming the cyclic structure contains only carbon atoms (i.e., no heteroatoms), although the boron group(s) and/or the other functional group(s) (when present) can contain other than carbon atoms). For example, the cyclic unsaturated hydrocarbon can be a substituted cyclopentadiene, a substituted benzene, a substituted naphthalene, a substituted anthracene, or a substituted perylene (i.e., where “substituted” corresponds to the presence of the boron group(s) and the other functional group(s) (when present) in the reactant).

In some embodiments, the unsaturated hydrocarbon reaction substrate is a heterocyclic unsaturated hydrocarbon (e.g., the hydrocarbon ring forming the cyclic structure contains carbon atoms and at least one heteroatom (e.g., 1, 2, or 3 heteroatoms). In particular, the heterocyclic unsaturated hydrocarbon can include one or more heteroatoms (generically represented as Y in the figures) such as nitrogen, oxygen, sulfur, phosphorous, and combinations thereof (e.g., includes one N, O, S, or P heteroatom; includes two or more same or different N, O, S, or P heteroatoms). The heteroatoms can be present in the heterocyclic unsaturated hydrocarbon in the form of —NH—, —NR—, —N═, —O—, —S—, —PH—, —PR—, and —P═, where R as a nitrogen or phosphorous substituent can be independently selected from the same options as the other functional group in the unsaturated hydrocarbon at a ring carbon (e.g., an sp²-carbon or an sp³-carbon in a partially unsaturated reaction substrate). In the unsaturated hydrocarbon reactant, the boron group can be at an sp²-carbon in a 2-position relative to the heteroatom (e.g., at a carbon atom in the heterocyclic ring which is adjacent to the heteroatom on either side of the heteroatom), the boron group can be at an sp²-carbon in a 3-position relative to the heteroatom (e.g., at a carbon atom in the heterocyclic ring which has one intervening carbon atom between it and the heteroatom on either side of the heteroatom), or the boron group can be at an sp²-carbon in a 4-position relative to the heteroatom (i.e., at a carbon atom in the heterocyclic ring which has two intervening carbon atoms between it and the heteroatom on either side of the heteroatom). Examples of a specific heterocyclic unsaturated hydrocarbons include a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, and a substituted diazene (i.e., where “substituted” corresponds to the presence of the boron group(s) and the other functional group(s) (when present) in the reactant, and a possible nitrogen- or phosphorous-atom substituent other than hydrogen when nitrogen or phosphorous is a heteroatom in the ring structure but with only two single bonds with adjacent ring atoms, carbon or otherwise (e.g., —NR— or —PR—)).

Various embodiments of the boron group are possible. Generally, after reduction (or hydrogenation) of the unsaturated hydrocarbon reactant, the boron groups in the reaction product remain unchanged, although they are typically attached to an sp³-carbon in the product as compared to an sp²-carbon in the reactant. In various embodiments, the boron group can be a boronic acid (e.g., —B(OH)₂), a boronic ester (e.g., —B(OR)₂), an alkyl boranes (e.g., —BR₂), a boryl halide (e.g., —BF₂ or with other halogens) or a haloborate salt thereof (e.g., —BF₃K or with other halogens/alkali metals), a cyclic derivative thereof (e.g., Bpin (pinacolato boronate) as a cyclic ester), a fused cyclic derivative thereof (e.g., —B(OR¹)R², where R² is a carbon- and/or nitrogen-containing group, where carbon or nitrogen is bonded to boron, forming a fused cyclic structure and bonded to a different carbon in the unsaturated hydrocarbon than that of the boron), a heteroatom-substituted derivative thereof (e.g., BMIDA (N-methyliminodiacetic acid) as a cyclic boronic ester with a nitrogen group; boron substituted with 1,8-diaminonapthalene (Bdan), 1,2-ethylene diamine (Ben), 1,2-N,N′-dimethylethylenediamine (Bdmen)), or a combination thereof (e.g., combinations of different functional groups in the same boron group, such as combinations of 2 or 3 different acid groups (OH), ester groups (OR), amide groups (NH₂, NHR, NR₂), halides or haloborate salts, and alkyl groups (R) in the same boron group).

In some embodiments, the cyclic or heterocyclic unsaturated hydrocarbon includes at least two boron groups (e.g., 2, 3, 4, 5, or 6 boron groups), such as where the boron groups are initially positioned at sp²-carbons in the unsaturated hydrocarbon reactant. The multiple boron groups in the hydrocarbon reactant and product can be the same groups or different groups (e.g., at least one Bpin group and at least one other group such as BMIDA). The boron groups can be positioned at corresponding sp³-carbons of the hydrocarbon product in a syn orientation (e.g., all of the boron groups in the product are so oriented). For example, both boron groups are oriented in the same up/down direction relative to the ring structure of the at least partially saturated cyclic or heterocyclic hydrocarbon product resulting from syn addition of hydrogen to the original sp²-carbons of the unsaturated hydrocarbon reactant. Such syn orientation in the hydrocarbon product, generally can apply to any combination of single or multiple boron groups and single or multiple other functional groups that are present at any sp²-carbons of the unsaturated hydrocarbon reactant when there are two or more total groups between boron groups and functional groups in the unsaturated hydrocarbon reactant. In various embodiments, at least 60% of the at least two boron groups (or boron and other groups) are positioned in the hydrocarbon product in a syn orientation (e.g., at least 60%, 75%, 85%, 90%, 95%, 98%, or 99% and/or up to 80%, 90%, 95%, 98%, 99%, or 100% on a number or molar basis). This reflects a selectivity for syn-addition over anti-addition during reduction or hydrogenation, where the remaining (minority, such as 40% or less or corresponding to any of the foregoing syn ranges) of groups are in an anti orientation in the hydrocarbon product.

Various embodiments of the other functional group (R) (when present) are possible. The other functional group (R) is not particularly limited and can include one or more of alkyl groups (e.g., C1-C20 linear or branched alkyl, such as having at least 1, 2, 3, 4, 6, or 8 carbon atoms and/or up to 4, 6, 8, 10, 12, 15, or 20 carbon atoms), fused cycloalkyl derivatives thereof, alkenyl groups (e.g., C1-C20 linear or branched alkenyl such as having at least 1, 2, 3, 4, 6, or 8 carbon atoms and/or up to 4, 6, 8, 10, 12, 15, or 20 carbon atoms; which alkenyl groups can be partially or completely saturated during reduction), aryl groups (e.g., phenyl, naphthyl such as having at least 6, 10, or 14 carbon atoms and/or up to 10, 14, or 20 carbon atoms; which can be partially or completely saturated during reduction or left intact), halogens (e.g., Cl, F, Br, I), ester groups (e.g., with either the carbonyl group or oxygen atom bound to the unsaturated hydrocarbon; —C(═O)OR or —OC(═O)R such as where R is alkyl as above), amide groups (e.g., with either the carbonyl group or nitrogen atom bound to the unsaturated hydrocarbon; —C(═O)NR¹R² or —NR¹C(═O)R² such as where R¹ is hydrogen or alkyl and R² is the same or different alkyl as above), silyl groups (e.g., —SiR₃, where R can be the same or different alkyl groups as above), and heteroatom-containing derivatives thereof. Multiple different functional groups (R) can be independently selected as substituents of the unsaturated hydrocarbon reactant. The functional group is generally in the same form in both the unsaturated hydrocarbon reactant and the hydrocarbon product, although some functional groups are converted upon reduction as well (e.g., partial or complete reduction of alkenyl functional groups such as to alkyl functional groups; partial or complete reduction of (hetero)aromatic functional groups such as to (hetero)cycloalkyl functional groups; removal of halogen substituents from an sp²-carbon, etc.).

The functional group can be positioned at an sp²- or sp³-carbon in the unsaturated hydrocarbon reactant and at an sp²- or sp³-carbon in the hydrocarbon product, depending on the initial carbon type and whether hydrogen was added thereto during reduction. Preferably, the functional group is positioned at an sp²-carbon of the unsaturated hydrocarbon reactant. For example, the boron group and the other functional group can be positioned at adjacent sp²-carbons of the unsaturated hydrocarbon, and the boron group and the other functional group can be positioned at corresponding adjacent sp³-carbons of the hydrocarbon product in a syn orientation (e.g., reflecting syn addition of hydrogen during reduction as noted above). In other embodiments, the boron group and the other functional group can be positioned at non-adjacent sp²-carbons of the unsaturated hydrocarbon, and the boron group and the other functional group can be positioned at corresponding adjacent sp³-carbons of the hydrocarbon product in a syn orientation. Preferably, in either case, at least 60% of the boron groups and the other functional groups are positioned in the hydrocarbon product in a syn orientation (e.g., at least 60%, 75%, 85%, 90%, 95%, 98%, or 99% and/or up to 80%, 90%, 95%, 98%, 99%, or 100% on a number or molar basis) Similarly to the case noted above for multiple boron groups, this reflects a selectivity for syn-addition over anti-addition during reduction or hydrogenation, where the remaining (minority) of groups are in an anti orientation in the hydrocarbon product.

Various embodiments of the reduction process are possible for converting the unsaturated hydrocarbon reactant to the hydrocarbon product, which generally can be a heterogeneous or homogenous reaction process. For example, reduction of an unsaturated hydrocarbon reactant can be performed by hydrogenation. Hydrogenation is suitably performed using hydrogen (H₂) as a hydrogenation co-reactant and in the presence of a heterogeneous hydrogenation catalyst (e.g., in a liquid reaction medium/solvent for the unsaturated hydrocarbon reactant with the heterogeneous hydrogenation catalyst suspended therein and with the hydrogen gas dispersed and/or dissolved therein). The heterogeneous hydrogenation catalyst suitably includes a catalytic metal such as rhodium, palladium, platinum, iridium, ruthenium, nickel, osmium, and combinations (e.g., mixtures, alloys, etc.) thereof, where the metal can be supported on a suitable substrate such as carbon, alumina, etc. In some embodiments, hydrogenation can be performed as a homogeneous reaction process, for example catalytic homogeneous hydrogenations that product racemic products (achiral catalysts) and chiral products (chiral catalysts). Common chiral catalysts include diphosphines and chiral chelating ligands with one phosphorous and one nitrogen donor, or two nitrogen donors. In some embodiments, reduction of the cyclic or heterocyclic unsaturated hydrocarbon is in the presence of a homogeneous reduction catalyst (e.g., in a liquid reaction medium/solvent for the unsaturated hydrocarbon reactant with the homogeneous reduction catalyst also dissolved therein). An example of a suitable homogeneous reduction catalyst is sodium borohydride.

The unsaturated hydrocarbon reactant including the boron group in any particular location of the cyclic or heterocyclic ring structure (e.g., any spatial relationship relative to heteroatoms and/or other function groups, when present) can be provided by any of a variety of synthetic methods known in the art. Specifically, suitable techniques for borylation of an unsaturated cyclic or heterocyclic substrate (e.g., without any boron groups initially) are known and can be selected based on the underlying unsaturated cyclic or heterocyclic substrate, the type and position of the boron groups to be added, the type and position of other functional groups (when present), etc., for example as illustrated in the Cho et al. (2002), Maleczka et al. (2003), Holmes et al. (2006), and Shi et al. (2006) references noted below.

In some embodiments, methods according to the disclosure include a preliminary step of borylation to provide the cyclic or heterocyclic unsaturated hydrocarbon. For example, the borylated cyclic or heterocyclic unsaturated hydrocarbon reactant can be provided by borylating a corresponding cyclic or heterocyclic unsaturated hydrocarbon precursor without the at least one boron group to form unsaturated hydrocarbon reactant with the boron group added to an sp²-carbon of the unsaturated hydrocarbon reactant. The other functional group (when included) can be present/added to the reaction substrate either before or after the borylation step. In various refinements, the unsaturated hydrocarbon precursor can be completely free of boron groups and/or other boron substituents, all of which are added in the borylation reaction step at sp²-carbons of the precursor. Alternatively, the hydrocarbon precursor can already include one or more boron groups and/or other boron substituents, and the borylation reaction step adds further boron groups at other sp²-carbons of the precursor. In another refinement, borylation of the unsaturated hydrocarbon precursor and the reduction of the unsaturated hydrocarbon can be performed in the same reaction vessel (e.g., a one-pot synthesis of the final at least partially saturated corresponding cyclic or heterocyclic hydrocarbon product in the same reaction vessel with the two reactions performed in series, such as in the same (solvent) reaction medium, but with addition or exchange of (heterogeneous) catalytic materials and/or co-reactants (such as borylating group in the borylation step and hydrogen in the reduction/hydrogenation step) between the two reactions).

### Saturated (Hetero)Cyclic Borylated Hydrocarbon Compounds

In another aspect, the disclosure relates to a cyclic or heterocyclic hydrocarbon product which can be formed, for example, by the foregoing methods in their variously disclosed embodiments. The hydrocarbon product is an at least partially saturated cyclic or heterocyclic hydrocarbon including at least one boron group at an sp³-carbon of the hydrocarbon product, where the type, number, positioning, etc. of the boron groups are as described above. The hydrocarbon product further can include at least one other functional group at an sp³-carbon of the hydrocarbon product (or an sp²-carbon which was not reduced), where the type, number, positioning, etc. of the other functional groups (R) are as described above. In various embodiments, the hydrocarbon product is an at least partially saturated (e.g., completely saturated) cyclic or heterocyclic analog of the cyclic or heterocyclic unsaturated hydrocarbon reactant, which corresponding original reactant can be a substituted cyclopentadiene, a substituted benzene, a substituted naphthalene, a substituted anthracene, a substituted perylene, a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, or a substituted diazene.

### EXAMPLES

The following examples include illustrative embodiments of the disclosed methods for forming an at least partially saturated cyclic or heterocyclic borylated hydrocarbon, resulting hydrocarbon products formed therefrom, and illustrative subsequent synthetic utility of such organoboron products(e.g., as precursors for medicinal compound synthesis). In particular, the following examples illustrate methods and related compounds according to the disclosure for borylation of an unsaturated cyclic or heterocyclic hydrocarbon substrate, followed by reduction of the same to provide an at least partially saturated product. Scheme 7 illustrates an exemplary case for (1) sp²-carbon borylation using B₂Pin₂ or HBPin with an iridium-based catalyst ((1,5-cyclooctadiene)(methoxy)iridium(I) dimer ([IrOMe(cod)]₂) of a substituted or unsubstituted benzene or pyridine substrate followed by (2) hydrogenation of the sp²-carbon borylated product to form a corresponding saturated cyclic sp³-carbon borylated product.

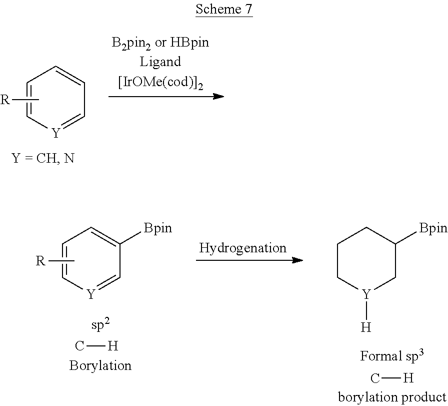

### Example 1

Example 1 illustrates the sp²-carbon borylation and hydrogenation of substituted (e.g., halogen- or alkyl-substituted) pyridine substrates to form a corresponding 2-, 3-, or 4-substituted sp³-carbon borylated piperidine.

Scheme 8 illustrates sp²-carbon borylation of a 2,5-dichloropyridine with an iridium-based catalyst ([IrOMe(cod)]₂ and 4,4′-di-tert-butyl-2,2′-bipyridine (dtbpy)) in tetrahydrofuran (THF; room temperature (rt) for 4 h). The sp²-carbon borylated product is hydrogenated using hydrogen (H₂) with a rhodium-based catalyst (Rh/Al₂O₃) in ethanol (EtOH; rt for 24 h) to form the corresponding hydrogenated, de-halogenated, 4-substituted sp³-carbon borylated piperidine product.

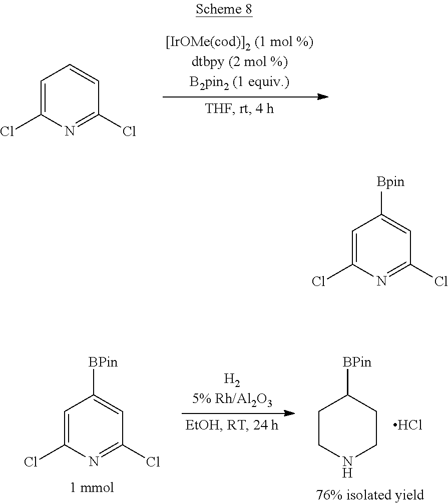

Scheme 9 illustrates sp²-carbon borylation of a 2,6-dimethylpyridine with an iridium-based catalyst ([IrOMe(cod)]₂ and dtbpy) in tetrahydrofuran (70° C. for 16 h). The sp²-carbon borylated product is hydrogenated using hydrogen with a rhodium-based catalyst (Rh/Al₂O₃) in ethanol (rt for 16 h) to form the corresponding hydrogenated, 4-substituted sp³-carbon borylated piperidine product.

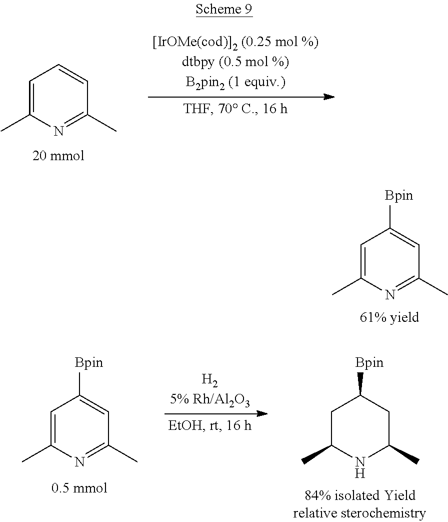

Scheme 10 illustrates hydrogenation and de-halogenation of an sp²-carbon 3-borylated-5-bromopyridine (e.g., which can be formed as illustrated above from a corresponding non-borylated substrate) using hydrogen with a rhodium-based catalyst (Rh/C) in ethanol (rt for 16 h) to form the corresponding hydrogenated, de-halogenated, 3-substituted sp³-carbon borylated piperidine product.

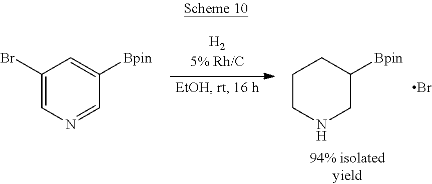

Scheme 11 illustrates hydrogenation and de-halogenation of an sp²-carbon 2-borylated-6-bromopyridine (e.g., which can be formed as illustrated above from a corresponding non-borylated substrate) using hydrogen with a rhodium-based catalyst (Rh/C) in ethanol (rt for 16 h) to form the corresponding hydrogenated, de-halogenated, 2-substituted sp³-carbon borylated piperidine product.

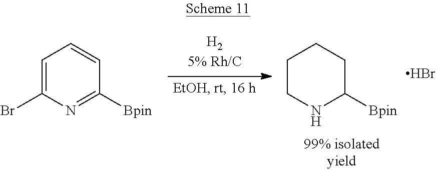

### Example 2

Example 2 illustrates the sp²-carbon borylation and hydrogenation of a furan substrate to form a corresponding 2-substituted sp³-carbon borylated tetrahydrofuran. Scheme 12 illustrates sp²-carbon borylation of furan with an iridium-based catalyst ([IrOMe(cod)]₂ and dtbpy) in hexane (rt for 16 h). The sp²-carbon borylated product is hydrogenated using hydrogen with a rhodium-based catalyst (Rh/Al₂O₃) in ethanol (rt for 15 h) to form the corresponding hydrogenated, 2-substituted sp³-carbon borylated tetrahydrofuran product.

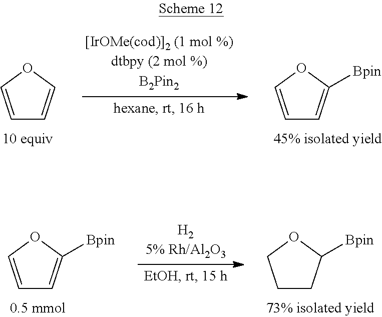

### Example 3

Example 3 illustrates the sp²-carbon borylation and hydrogenation of a silylated pyrrole substrate to form a corresponding 3-substituted sp³-carbon borylated pyrrolidine.

Scheme 13 illustrates the 5-silylation of N-tert-butyloxycarbonyl pyrrole using trimethylchlorosilane (TMSCI) with a lithium-based catalyst (n-butyl lithium (n-BuLi) and 2,2,6,6-tetramethylpiperidine) in diethyl ether (Et₂O; 78° C.). The silylated product is then sp²-carbon borylated with an iridium-based catalyst ([IrOMe(cod)]₂ and dtbpy) in tetrahydrofuran. The sp²-carbon borylated product is hydrogenated using hydrogen with a rhodium-based catalyst (Rh/C) in ethanol (rt for 16 h) to form the corresponding hydrogenated, silylated, 3-substituted sp³-carbon borylated pyrrolidine product.

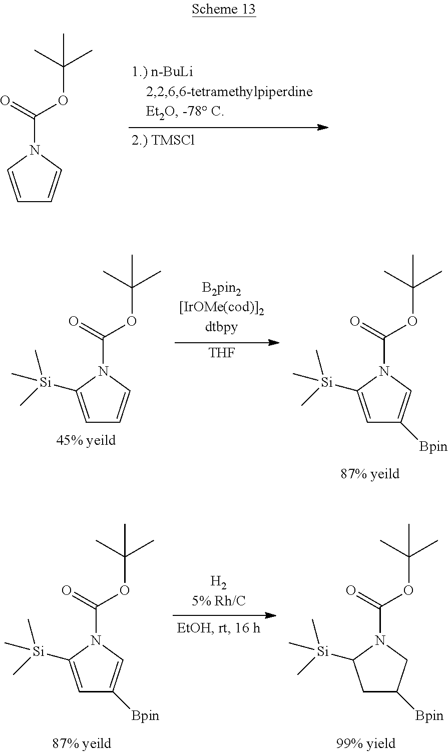

### Example 4

Example 4 illustrates the hydrogenation and reduction of sp²-carbon borylated, alkylated heteroaromatic compounds to form the corresponding saturated sp³-carbon borylated, alkylated heterocyclic compounds.

Scheme 14 illustrates alkylation of a 2,6-dimethyl-4-borylated pyridine (sp²-carbon borylated compound which can be formed as illustrated above from a corresponding non-borylated substrate) using iodomethane to form the corresponding N-methyl-2,6-dimethyl-4-borylated pyridinium iodide salt, followed by reduction/hydrogenation with sodium borohydride (NaBH₄) in ethanol (rt) to form the corresponding hydrogenated N-methyl-2,6-dimethyl-4-borylated piperidine (sp³-carbon borylated) product.

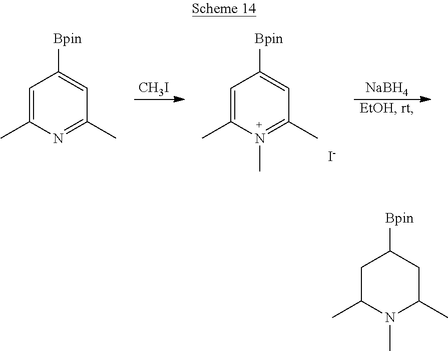

Scheme 15 illustrates alkylation of a N-methyl-2-borylated pyrazole (sp²-carbon borylated compound which can be formed as illustrated above from a corresponding non-borylated substrate) using iodomethane to form the corresponding N,N-dimethyl-2-borylated pyrazolium iodide salt, followed by reduction/hydrogenation with sodium borohydride in tetrahydrofuran (rt) to form the corresponding hydrogenated N,N-dimethyl-2-borylated pyrazolidine (sp³-carbon borylated) product.

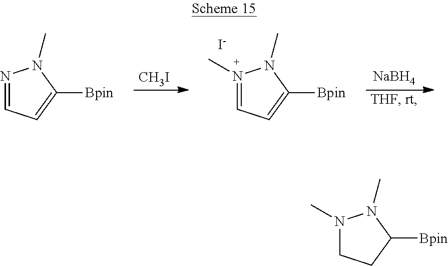

### Example 5

Example 5 illustrates the hydrogenation and reduction of sp²-carbon borylated isoquinoline to form a corresponding partially saturated sp³-carbon borylated analog.

Scheme 16 illustrates hydrogenation of an sp²-carbon borylated isoquinoline (e.g., which can be formed as illustrated above from a corresponding non-borylated substrate) using hydrogen with a rhodium-based catalyst (Rh/C) in ethanol (rt for 16 h) to form the corresponding hydrogenated, partially saturated sp³-carbon borylated analog product.

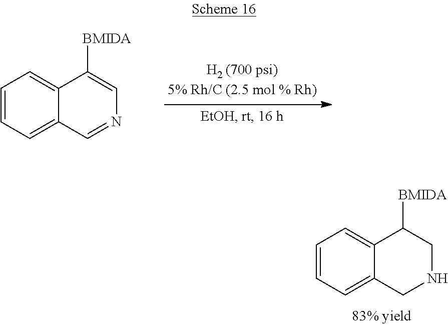

### Example 6

Example 6 illustrates the hydrogenation and reduction of substituted and unsubstituted sp²-carbon 3-borylated benzenes to form the corresponding sp³-carbon borylated cyclohexane.

Scheme 17 illustrates hydrogenation of a substituted (e.g., trifluoromethyl- or methoxycarbonyl-substituted) or unsubstituted sp²-carbon borylated benzene (e.g., which can be formed as illustrated above from a corresponding non-borylated substrate) using hydrogen with a rhodium-based catalyst (Rh/C) in ethanol (rt for 16 h) to form the corresponding substituted or unsubstituted sp³-carbon borylated cyclohexane product.

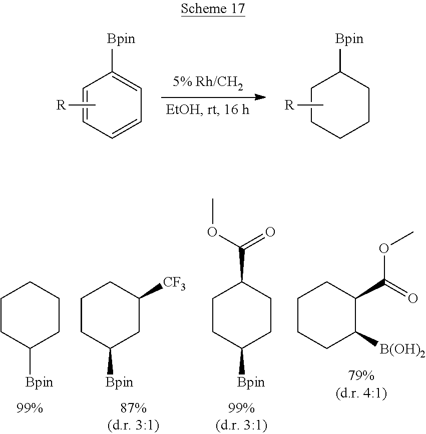

### Example 7

Example 7 illustrates the hydrogenation and reduction of substituted and unsubstituted sp²-carbon borylated unsaturated heterocycles to form a corresponding sp³-carbon borylated saturated heterocycle.

Scheme 18 illustrates hydrogenation of a substituted (e.g., methyl-, dimethyl-, or trimethylsilyl-substituted) or unsubstituted sp²-carbon unsaturated heterocycles (e.g., which can be formed as illustrated above from a corresponding non-borylated substrate) using hydrogen with a heterogeneous catalyst in ethanol (rt for 16 h) to form the corresponding substituted or unsubstituted sp³-carbon borylated saturated heterocycle product.

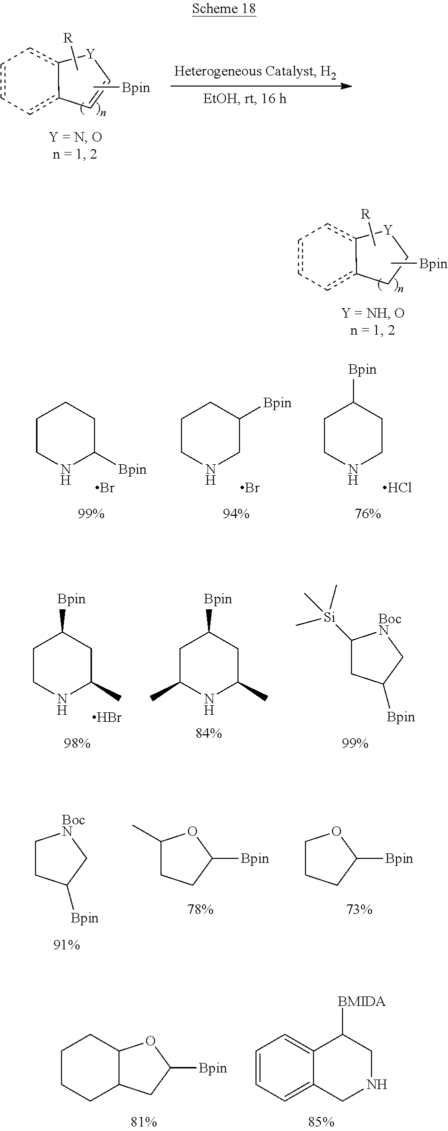

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

1. “Escape from Flatland: Increasing Saturation as an Approach to Improving Clinical Success” Lovering, F.; Bikker, J.; Humblet, C. J. Med. Chem. 2009, 52, 6752-6756.
2. “An improved synthesis of homoproline and derivatives” Shuman, R. T.; Ornstein, P. L.; Paschal, J. W.; Gesellchen, P. D. J. Org. Chem. 1990, 55, 738-741.
3. “Catalytic enantioselective [4+2]-cycloaddition: a strategy to access aza-hexacycles” Masson, G.; Lalli, C.; Benohoud, M.; Dagousset, G. Chem. Soc. Rev. 2013, 42, 902-923.
4. “The Medicinal Chemist's Toolbox: An Analysis of Reactions Used in the Pursuit of Drug Candidates” Roughley, S. D.; Jordan, A. M. J. Med. Chem. 2011, 54, 3451-3479.
5. “The efficient synthesis and simple resolution of a prolineboronate ester suitable for enzyme-inhibition studies” Kelly, T. A.; Fuchs, V. U.; Perry, C. W.; Snow, R. J. Tetrahedron 1993, 49, 1009-1016.
6. “Asymmetric Hydrogenation of Pyridinium Salts with an Iridium Phosphole Catalyst” Chang, M.; Huang, Y.; Liu, S.; Chen, Y.; Krska, S. W.; Davies, I. W.; Zhang, X. Angewandte Chemie-International Edition 2014, 53, 12761-12764.
7. “Catalytic Asymmetric Hydrogenation of N-Boc-Imidazoles and Oxazoles” Kuwano, R.; Kameyama, N.; Ikeda, R. Journal of the American Chemical Society 2011, 133, 7312-7315.
8. Cho, J. Y.; Tse, M. K.; Holmes, D.; Maleczka, R. E., Jr.; Smith, M. R., III Science 2002, 295, 305-308.
9. Maleczka, R. E., Jr.; Shi, F.; Holmes, D.; Smith, M. R., III J. Am. Chem. Soc. 2003, 125, 7792-7793.
10. Holmes, D.; Chotana, G. A.; Maleczka, R. E., Jr.; Smith, M. R., III Org. Lett. 2006, 8, 1407-1410.
11. Shi, F.; Smith, M. R., III; Maleczka, R. E., Jr. Org. Lett. 2006, 8, 1411-1414.

What is claimed is:

1. A method for forming an at least partially saturated cyclic or heterocyclic borylated hydrocarbon, the method comprising:
(a) providing a cyclic or heterocyclic unsaturated hydrocarbon comprising
(i) at least one boron group at an sp²-carbon of the unsaturated hydrocarbon, and
(ii) optionally at least one other functional group at an sp²-carbon of the unsaturated hydrocarbon,
wherein the cyclic or heterocyclic unsaturated hydrocarbon has at least one of the following characteristics:
(A) the cyclic or heterocyclic unsaturated hydrocarbon comprises the at least one other functional group;
(B) the cyclic or heterocyclic unsaturated hydrocarbon is other than a substituted pyrrole;
(C) the cyclic or heterocyclic unsaturated hydrocarbon is a heterocyclic unsaturated hydrocarbon comprising a heteroatom selected from the group consisting of nitrogen, oxygen, sulfur, and combinations thereof, wherein the heteroatom is in the form of —-NH—, —NR—, —N═, —O—, —S—, —PH—, —PR—, and —P═, where R, when present, is selected from the group consisting of alkyl groups, fused cycloalkyl derivatives thereof, aryl groups, halogens, amide groups, silyl groups, and heteroatom-containing derivatives thereof; and
(D) the cyclic or heterocyclic unsaturated hydrocarbon is a cyclic unsaturated hydrocarbon; and
(b) reducing the cyclic or heterocyclic unsaturated hydrocarbon, thereby forming an at least partially saturated corresponding cyclic or heterocyclic hydrocarbon product comprising the at least one boron group at an sp³-carbon of the at least partially saturated hydrocarbon product.

2. The method of claim 1, wherein the cyclic or heterocyclic unsaturated hydrocarbon is other than a substituted pyrrole.

3. The method of claim 1, wherein the cyclic or heterocyclic unsaturated hydrocarbon is a cyclic unsaturated hydrocarbon.

4. The method of claim 3, wherein the cyclic unsaturated hydrocarbon is selected from the group consisting of a substituted cyclopentadiene, a substituted benzene, a substituted naphthalene, a substituted anthracene, and a substituted perylene.

5. The method of claim 1, wherein the cyclic or heterocyclic unsaturated hydrocarbon is a heterocyclic unsaturated hydrocarbon.

6. The method of claim 5, wherein the heterocyclic unsaturated hydrocarbon comprises a heteroatom selected from the group consisting of nitrogen, oxygen, sulfur, phosphorous, and combinations thereof.

7. The method of claim 6, wherein the boron group is at an sp²-carbon in a 2-position relative to the heteroatom.

8. The method of claim 6, wherein the boron group is at an sp²-carbon in a 3-position relative to the heteroatom.

9. The method of claim 6, wherein the boron group is at an sp²-carbon in a 4-position relative to the heteroatom.

10. The method of claim 5, wherein the heterocyclic unsaturated hydrocarbon is selected from the group consisting of a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, and a substituted diazene.

11. The method of claim 1, wherein the cyclic or heterocyclic unsaturated hydrocarbon is fully unsaturated.

12. The method of claim 1, wherein the cyclic or heterocyclic unsaturated hydrocarbon is partially unsaturated.

13. The method of claim 1, wherein the boron group is selected from the group consisting of boronic acids, boronic esters, alkyl boranes, boryl halides and haloborate salts thereof, cyclic derivatives thereof, fused cyclic derivatives thereof, heteroatom-substituted derivatives thereof, and combinations thereof.

14. The method of claim 1, wherein the boron group is Bpin.

15. The method of claim 1, wherein the boron group is B(OH)₂.

16. The method of claim 1, wherein the boron group is BMIDA.

17. The method of claim 1, wherein the boron group is Bdan

18. The method of claim 1, wherein the boron group is Ben.

19. The method of claim 1, wherein the boron group is Bdmen.

20. The method of claim 1, wherein the cyclic or heterocyclic unsaturated hydrocarbon comprises at least two boron groups.

21. The method of claim 20, wherein the at least two boron groups are positioned at corresponding sp³-carbons of the hydrocarbon product in a syn orientation.

22. The method of claim 21, wherein at least 60% of the at least two boron groups are positioned in the hydrocarbon product in a syn orientation.

23. The method of claim 20, wherein the cyclic or heterocyclic unsaturated hydrocarbon comprises at least two different boron groups.

24. The method of claim 1, wherein the cyclic or heterocyclic unsaturated hydrocarbon comprises at least one other functional group.

25. The method of claim 24, wherein the other functional group is selected from the group consisting of alkyl groups, fused cycloalkyl derivatives thereof, alkenyl groups, aryl groups, halogens, ester groups, amide groups, silyl groups, and heteroatom-containing derivatives thereof.

26. The method of claim 24, wherein the other functional group is positioned at an sp²-carbon of the unsaturated hydrocarbon.

27. The method of claim 26, wherein:
the boron group and the other functional group are positioned at adjacent sp²-carbons of the unsaturated hydrocarbon, and
the boron group and the other functional group are positioned at corresponding adjacent sp³-carbons of the hydrocarbon product in a syn orientation.

28. The method of claim 27, wherein at least 60% of the boron groups and the other functional groups are positioned in the hydrocarbon product in a syn orientation.

29. The method of claim 26, wherein:
the boron group and the other functional group are positioned at non-adjacent sp²-carbons of the unsaturated hydrocarbon, and
the boron group and the other functional group are positioned at corresponding adjacent sp³-carbons of the hydrocarbon product in a syn orientation.

30. The method of claim 29, wherein at least 60% of the boron groups and the other functional groups are positioned in the hydrocarbon product in a syn orientation.

31. The method of claim 1, wherein reducing the cyclic or heterocyclic unsaturated hydrocarbon in part (b) comprises hydrogenating the cyclic or heterocyclic unsaturated hydrocarbon to form the corresponding hydrocarbon product.

32. The method of claim 31, comprising hydrogenating the cyclic or heterocyclic unsaturated hydrocarbon in the presence of a heterogeneous hydrogenation catalyst.

33. The method of claim 32, wherein the heterogeneous hydrogenation catalyst comprises a metal selected from the group consisting of rhodium, palladium, platinum, iridium, ruthenium, nickel, or osmium and combinations thereof.

34. The method of claim 31, comprising hydrogenating the cyclic or heterocyclic unsaturated hydrocarbon in the presence of a chiral hydrogenation catalyst.

35. The method of claim 1, comprising reducing the cyclic or heterocyclic unsaturated hydrocarbon in the presence of a homogeneous reduction catalyst.

36. The method of claim 35, wherein the homogeneous reduction catalyst comprises sodium borohydride.

37. The method of claim 1, wherein providing the cyclic or heterocyclic unsaturated hydrocarbon in part (a) comprises:
borylating a corresponding cyclic or heterocyclic unsaturated hydrocarbon precursor comprising the at least one other functional group (when present), but without the at least one boron group, thereby forming the cyclic or heterocyclic unsaturated hydrocarbon comprising the at least one boron group added to an sp²-carbon of the unsaturated hydrocarbon and the at least one other functional group (when present).

38. The method of claim 37, comprising performing the borylation of the unsaturated hydrocarbon precursor and the reduction of the unsaturated hydrocarbon in the same reaction vessel.

39. A cyclic or heterocyclic hydrocarbon product comprising:
an at least partially saturated cyclic or heterocyclic hydrocarbon product comprising:
(i) at least one boron group at an sp³-carbon of the hydrocarbon product, and
(ii) optionally at least one other functional group at an sp³-carbon of the hydrocarbon product;
wherein the at least partially saturated cyclic or heterocyclic hydrocarbon product has at least one of the following characteristics:
(A) the at least partially saturated cyclic or heterocyclic hydrocarbon product comprises the at least one other functional group;
(B) the at least partially saturated cyclic or heterocyclic hydrocarbon product is other than a partially or fully saturated substituted pyrrole analog;
(C) the at least partially saturated cyclic or heterocyclic hydrocarbon product is an at least partially saturated heterocyclic hydrocarbon product comprising a heteroatom selected from the group consisting of nitrogen, oxygen, sulfur, and combinations thereof, wherein the heteroatom is in the form of —NH—, —NR—, —N═, —O—, —S—, —PH—, —PR—, and —P═, where R, when present, is selected from the group consisting of alkyl groups, fused cycloalkyl derivatives thereof, aryl groups, halogens, amide groups, silyl groups, and heteroatom-containing derivatives thereof; and
(D) the at least partially saturated cyclic or heterocyclic hydrocarbon product is an at least partially saturated cyclic hydrocarbon product.

40. The hydrocarbon product of claim 39, wherein the hydrocarbon product is an at least partially saturated cyclic or heterocyclic analog of a cyclic or heterocyclic unsaturated hydrocarbon selected from the group consisting of a substituted cyclopentadiene, a substituted benzene, a substituted naphthalene, a substituted anthracene, a substituted perylene, a substituted pyrrole, a substituted indole, a substituted pyridine, a substituted quinoline, a substituted pyrimidine, a substituted quinazoline, a substituted pyrazine, a substituted quinoxaline, a substituted imidazole, a substituted benzoimidazole, a substituted oxazole, a substituted benzoxazole, a substituted furan, a substituted benzofuran, a substituted thiophene, a substituted benzothiophene, a substituted azaindole, a substituted thiazole, a substituted benzothiazole, a substituted pyrimidine, and a substituted diazene.

41. The hydrocarbon product of claim 39, wherein:
the hydrocarbon product is an at least partially saturated heterocyclic analog of a substituted pyrrole, and
the at least one other functional group is present as a silyl group.

42. The hydrocarbon product of claim 39, wherein:
the hydrocarbon product is an at least partially saturated heterocyclic analog of a substituted pyrrole,
the boron group is at an sp³-carbon in a 3-position relative to the nitrogen heteroatom of the hydrocarbon product, and
the at least one other functional group is present at an sp³-carbon in a 5-position relative to the nitrogen heteroatom of the hydrocarbon product.

43. The hydrocarbon product of claim 39, wherein:
the hydrocarbon product is an at least partially saturated heterocyclic analog of a substituted pyrrole,
the boron group is at an sp³-carbon in a 2-position relative to the nitrogen heteroatom of the hydrocarbon product, and
at least two other functional groups are present, including a first functional group at an sp³-carbon in a 4-position relative to the nitrogen heteroatom of the hydrocarbon product and a second functional group at an sp³-carbon in a 5-position relative to the nitrogen heteroatom of the hydrocarbon product.

44. The hydrocarbon product of claim 39, wherein the at least partially saturated cyclic or heterocyclic hydrocarbon product is selected from compounds 5-7, 10,12, 13, and 15 below:

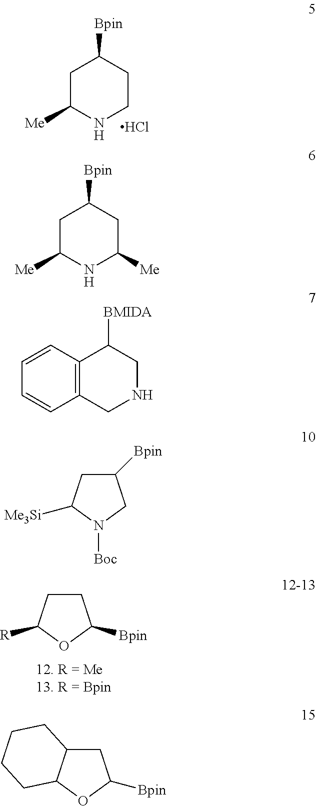

45. The hydrocarbon product of claim 39, wherein the at least partially saturated cyclic or heterocyclic hydrocarbon product is selected from compounds 17-21 below:

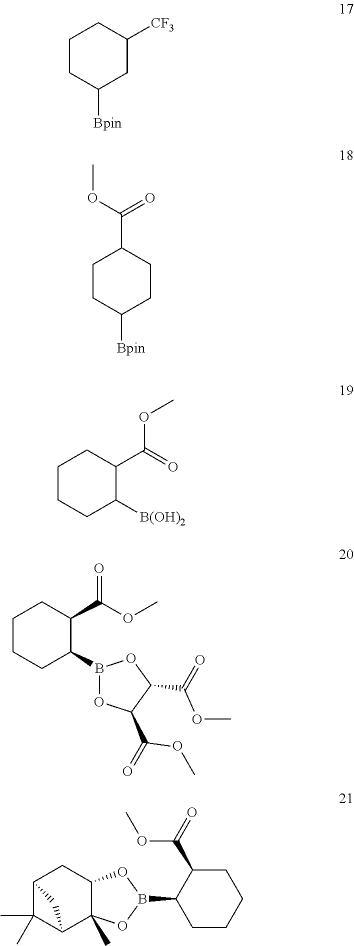

46. The hydrocarbon product of claim 39, wherein the at least partially saturated cyclic or heterocyclic hydrocarbon product is selected from the 2-borylated at least partially saturated pyridine analogs below:

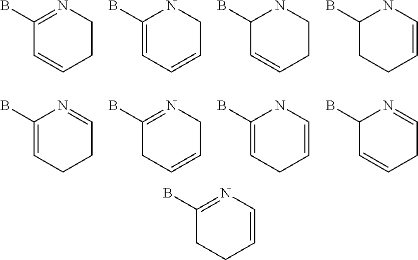

47. The hydrocarbon product of claim 39, which has been formed by the method of claim 1.

48. A method for forming an at least partially saturated cyclic or heterocyclic silylated hydrocarbon, the method comprising:
(a) providing a cyclic or heterocyclic unsaturated hydrocarbon comprising
(i) optionally at least one boron group at an sp²-carbon of the unsaturated hydrocarbon, and
(ii) at least one silyl functional group at an sp²-carbon or an sp³-carbon of the unsaturated hydrocarbon; and
(b) reducing the cyclic or heterocyclic unsaturated hydrocarbon, thereby forming an at least partially saturated corresponding cyclic or heterocyclic hydrocarbon product comprising the at least one silyl functional group at an sp³-carbon of the at least partially saturated hydrocarbon product.
